(19) United States
(12) Patent Application Publication
(10) Pub. No.: US 2026/0364961 A1
(43) Pub. Date: Nov. 19, 2026

(54) RECORDING APPARATUS

(71) Applicant: CANON KABUSHIKI KAISHA, Tokyo (JP)

(72) Inventors: RYOTA IMAI, Kanagawa (JP); YUMA SATO, Kanagawa (JP)

(21) Appl. No.: 19/670,174

(22) Filed: May 7, 2026

(30) Foreign Application Priority Data
May 16, 2025 (JP) 2025-082612

(51) Int. Cl. B41J 15/04; B41J 3/46; B41J 29/18; B41J 29/387

(52) U.S. Cl. CPC B41J 15/04; B41J 3/46; B41J 29/18; B41J 29/387

(57) ABSTRACT

A recording apparatus includes: a recording portion; a first discharge portion configured to discharge the recording material in a posture where a recording surface is not visually recognizable; a second discharge portion configured to discharge the recording material in a posture where the recording surface is visually recognizable; and a control portion configured to control the recording portion and conveyance of the recording material. The control portion performs a discharge operation that includes discharging a portion of the recording material to the second discharge portion, then returning the recording material from the second discharge portion, and then discharging the recording material from the first discharge portion. During the discharge operation, the control portion temporarily stops the conveyance of the recording material and the recording of the image while at least a portion of the recording surface of the recording material is visually recognizable from outside.

### BACKGROUND

### Field of the Technology

The present disclosure relates to a recording apparatus including a plurality of discharge paths for discharging a recording material.

### Description of the Related Art

In large-sized inkjet recording apparatuses, recording is performed using a roll-shaped sheet. Furthermore, as recording apparatuses of this type, apparatuses including a plurality of sheet discharge paths are known. Japanese Patent Application Laid-open No. 2022-57291 discloses a technology for automatically switching a sheet discharge destination in accordance with conveyance conditions or a thickness of a conveyed sheet.

Conventionally, when upper sheet discharge is performed, a user cannot confirm a result during recording. Furthermore, even if printing is performed in an unintended layout, the user cannot recognize the layout before completion of the printing and therefore cannot take measures such as interruption of the printing.

### SUMMARY

The present disclosure is directed to provide a technology capable of reducing wasteful recording operations.

According to some embodiments, the recording apparatus of the present disclosure is characterized by features including:
a recording portion configured to record an image on a recording material;
a first discharge portion configured to discharge the recording material in a posture in which a recording surface on which the image has been recorded by the recording portion is not visually recognizable from outside;
a second discharge portion configured to discharge the recording material in a posture in which the recording surface on which the image has been recorded by the recording portion is visually recognizable from outside; and
a control portion configured to control the recording portion and conveyance of the recording material, wherein the control portion performs a discharge operation that includes discharging a portion of the recording material on which the image has been recorded by the recording portion to the second discharge portion, then returning the recording material from the second discharge portion, and then discharging the recording material from the first discharge portion, and
during the discharge operation, the control portion temporarily stops the conveyance of the recording material and the recording of the image while at least a portion of the recording surface of the recording material on which the image has been recorded by the recording portion is visually recognizable from outside.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of a recording apparatus according to this embodiment.

FIG. 2 is a schematic perspective view of the recording apparatus during a front sheet discharge operation.

FIG. 3 is a schematic cross-sectional view of the recording apparatus during the front sheet discharge operation.

FIG. 4 is a schematic perspective view of the recording apparatus during an upper sheet discharge operation.

FIG. 5 is a schematic cross-sectional view of the recording apparatus during the upper sheet discharge operation.

FIG. 6 is a flowchart of the upper sheet discharge operation.

FIG. 7 is a flowchart of a third sheet discharge operation according to a first embodiment.

FIG. 8 is a schematic cross-sectional view of the recording apparatus after a rewinding operation is performed by a predetermined amount.

FIG. 9 is a flowchart of the third sheet discharge operation according to a modified example of this embodiment.

FIG. 10 is a flowchart of a recording result confirmation operation according to a second embodiment.

FIG. 11 is a flowchart of the recording result confirmation operation according to the second embodiment.

FIG. 12 is a diagram illustrating a screen for confirming whether to continue recording.

FIG. 13 is a diagram illustrating a screen for confirming a change in settings.

FIG. 14 is a flowchart of a recording result confirmation operation according to a third embodiment.

### DESCRIPTION OF THE EMBODIMENTS

Hereinafter, with reference to the drawings, embodiments for carrying out the present disclosure will be exemplarily described in detail on the basis of examples. However, the dimensions, materials, shapes, relative arrangements, and the like of the components described in the embodiments may be appropriately modified depending on the configurations and various conditions of the apparatus to which the present disclosure is applied. That is, the scope of the present disclosure is not intended to be limited to the embodiments described below. Furthermore, although a plurality of features are described in the embodiments, all the features are not necessarily essential to the present disclosure, and the features may be combined arbitrarily. In addition, in the accompanying drawings, the same reference numerals denote the same or similar components, and redundant descriptions thereof are be omitted.

Note that in the description of the following embodiments, the term “recording” (which may also be referred to as “printing”) refers not only to forming meaningful information such as characters and graphics, but also broadly to forming information such as images, designs, or patterns on a sheet. Furthermore, although a roll sheet is assumed as a recording material in the embodiments, cut paper, fabrics, plastic films, or the like may also be used. In addition, “ink” should be broadly interpreted and refers to any liquid that, when applied to a sheet, can be used to form images, designs, patterns, or the like, to process the sheet, or to treat the ink itself.

Hereinafter, a printer of an inkjet system will be described as an example of a recording apparatus. However, the printing system is not limited to the inkjet system, and various other systems, including electrophotographic systems and thermal transfer systems, are also applicable. Inkjet systems may include various systems, such as systems using heating elements, systems using piezoelectric elements, systems using electrostatic elements, and systems using MEMS elements. Furthermore, the present disclosure is also applicable to composite apparatuses having a copying function and a scanning function, that is, so-called multifunction printers.

In the drawings, X and Y indicate two axial directions that are orthogonal to each other on a horizontal plane, and Z indicates a vertical direction. In addition, the direction indicated by arrow Y represents a direction from a rear side toward a front side in a front-rear direction of the recording apparatus according to the present embodiment. Furthermore, the direction indicated by arrow X represents a width direction of the recording apparatus according to the present embodiment and a direction from a left side toward a right side of the recording apparatus. Furthermore, in each drawing, the recording apparatus is illustrated as being installed on a horizontal plane in a normally assumed installation state.

The recording apparatus according to the present embodiment is characterized in that, in an apparatus configuration in which a recording material is discharged as a discharge mode (sheet discharge mode) in a posture in which a recording surface cannot be visually recognized from outside, a user is enabled to visually recognize a recorded portion of an image being recorded from outside before the recording is completed. By visually recognizing the recorded portion of the image being recorded before completion of the recording, the user is able to confirm a state of the image to be formed prior to completion of the recording and determine whether to continue the recording on the image as it is or to stop the recording and review settings or the like.

For example, when recording (continuous printing) is continuously performed on a plurality of recording materials, the recording apparatus temporarily stops the recording during recording of a first sheet such that a state of a recorded image can be visually recognized. When continuation of the recording is permitted, the recording apparatus resumes the recording and controls second and subsequent sheets to be recorded sequentially. For example, the recording apparatus is configured to request a user, via a UI, to confirm a recorded image and input only a continuation instruction when the user wishes to continue the recording. Conventionally, the user needs to be instructed twice. First, the user provides a printing instruction for a first sheet, confirms the printed sheet, and thereafter provides another printing instruction for subsequent sheets. However, the printing apparatus requests only one printing instruction and therefore is expected to reduce a user’s operational load. When the quality of the first printed sheet is not desirable, the printing apparatus stops the continuous printing halfway through printing of the first sheet and reviews or corrects necessary print settings, thereby enabling the user to perform continuous printing with the changed settings. That is, when a printing instruction is provided for a plurality of sheets using undesirable settings, the user becomes aware of the need to correct the settings at the timing when a first sheet is printed, and stops printing of second and subsequent sheets, thereby making it possible to reduce wasted ink and recording sheets.

### FIRST EMBODIMENT

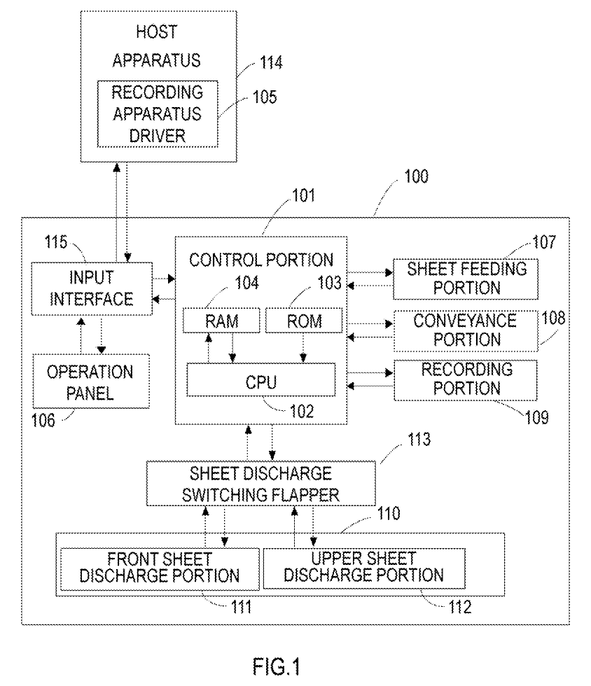

FIG. 1 is a block diagram of a recording apparatus 100 according to this embodiment. The recording apparatus 100 includes a control portion 101 including a processor such as a CPU 102 and storage devices such as a ROM 103 and a RAM 104. The recording apparatus 100 further includes an operation panel 106 that serves as an interface with a user, and an input interface 115 that communicates with a recording apparatus driver 105 provided in an external host apparatus 114. The CPU 102 receives, from the recording apparatus driver 105 of the external host apparatus 114 via the input interface 115, image data and setting information including settings for a paper discharge destination or the like. The host apparatus 114 serves as an image data supply source, and may specifically be a reader portion for reading images, as well as a computer that generates data such as images to be recorded and performs various types of processing. A discharge method for discharging a recorded matter on which image data has been recorded can be set via the recording apparatus driver 105 of the external host apparatus 114 or via the operation panel 106.

The recording apparatus 100 includes a supply portion 107 that feeds a roll sheet and a conveyance portion 108 that conveys the roll sheet to a recording portion 109 or a sheet discharge portion 110. The sheet discharge portion 110 includes a front sheet discharge portion 111 that discharges the sheet to a front side of the apparatus and an upper sheet discharge portion 112 that discharges the sheet to an upper side of the apparatus. The sheet discharge direction can be set, for example, via the operation panel 106 or the recording apparatus driver 105. A sheet discharge switching flapper 113 is arranged at a branch point between a path leading to the upper sheet discharge portion 112, which serves as a first discharge portion, and a path leading to the front sheet discharge portion 111, which serves as a second discharge portion. The sheet discharge switching flapper 113 is selectively movable between a first posture that permits a sheet 2 to move toward the upper sheet discharge portion 112 while restricting the sheet 2 from moving toward the front sheet discharge portion 111 and a second posture that restricts the sheet 2 from moving toward the upper sheet discharge portion 112 while permitting the sheet 2 to move toward the front sheet discharge portion 111. The control portion 101 switches the posture of the sheet discharge switching flapper 113 in accordance with a set sheet discharge direction, and controls conveyance of the sheet 2 such that the sheet 2 drawn out from a rolled portion R of the roll sheet is conveyed to one of the front sheet discharge portion 111 and the upper sheet discharge portion 112. In the front sheet discharge portion 111, the sheet 2 is discharged in a posture in which at least a portion of an image being recorded can be visually recognized from outside. More specifically, the sheet 2 is discharged with a recording surface thereof facing the front side of the apparatus and a leading end side thereof hanging down. In the upper sheet discharge portion 112, the sheet 2 is discharged in a posture in which a recording surface on which an image has been recorded cannot be visually recognized from outside. More specifically, the sheet 2 is stacked such that the recording surface of the sheet 2 faces a stacking surface of the upper sheet discharge portion 112.

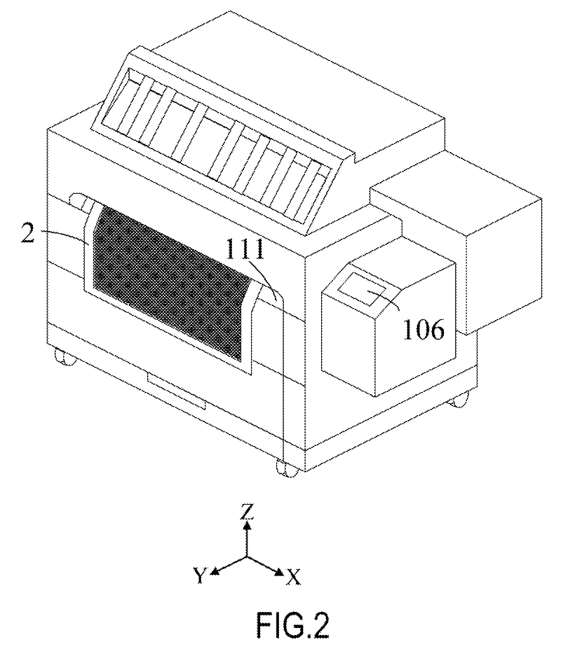

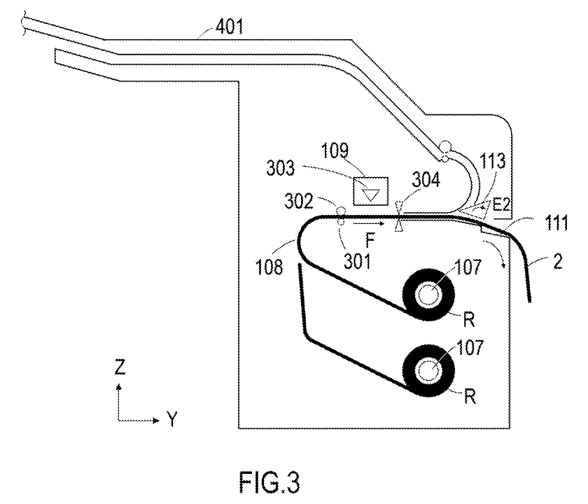

FIG. 2 is a schematic perspective view of the recording apparatus 100 during front sheet discharge. FIG. 3 is a schematic cross-sectional view of the recording apparatus 100 during the front sheet discharge. During the front sheet discharge, the sheet 2 is discharged with a recording region (recording surface) thereof facing upward, that is, with the recording region being visually recognizable from outside. Therefore, a user can visually recognize a recording result even during a sheet discharge operation. Furthermore, with reference to FIG. 3, control up to the front sheet discharge will be schematically described. When a rolled portion R of a roll sheet is set in the supply portion 107, the sheet 2 is drawn out from the rolled portion R toward the conveyance portion 108, thereby starting feeding of the sheet 2. This feeding operation is performed automatically by the supply portion 107, or is performed in such a manner that the user manually draws out the sheet 2 from the rolled portion R. Note that in this specification, the sheet 2 and the rolled portion R refer to the same recording material (recording medium), but are described separately for convenience of explanation. That is, a portion of a roll sheet serving as a recording sheet and wound in a roll shape in the supply portion 107 is defined as the rolled portion R, and a sheet-shaped portion drawn out from the rolled portion R is defined as the sheet 2. The sheet 2 drawn out from the rolled portion R by the supply portion 107 is conveyed by the conveyance portion 108 along a conveyance path to the recording portion 109, which is capable of recording images.

The sheet 2 conveyed to the recording portion 109 is conveyed in a conveyance direction F by a conveyance roller 301. A nip roller 302 can be driven to rotate in accordance with rotation of the conveyance roller 301. The recording portion 109 includes an optical sensor 303, and the sheet 2 is conveyed to a position at which the sheet 2 is detectable by the optical sensor 303.

The recording portion 109 records a designated image on the sheet 2. The recording portion 109 includes an inkjet-type recording head and records an image on the sheet 2 by ejecting ink from the recording head. The recording head ejects ink from ejection ports using, for example, ejection energy generating elements such as electrothermal conversion elements (heaters) or piezoelectric elements. Note that the recording head is not limited to an inkjet type. Furthermore, the recording system of the recording portion 109 may be, for example, a serial scan system or a full-line system. In the serial scan system, a conveyance operation of the sheet 2 and an image recording operation accompanied by scanning of the recording head in a direction intersecting a conveyance direction of the sheet 2 are alternately performed, thereby recording an image. In the full-line system, a long recording head extending in a direction intersecting the conveyance direction of the sheet 2 is used, and an image is recorded while the sheet 2 is continuously conveyed.

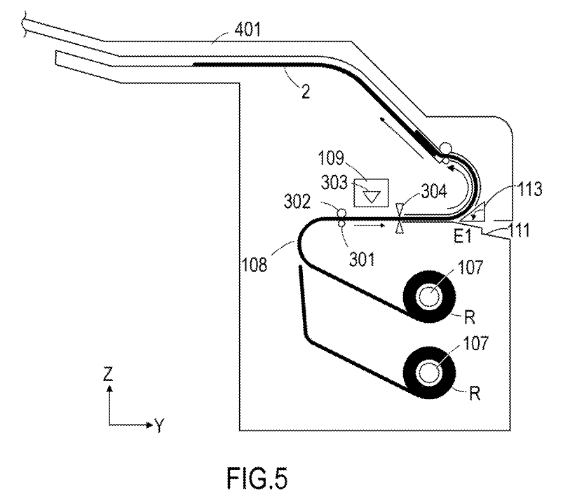

A cutter 304 is arranged downstream of the recording portion 109 in the conveyance direction F. When recording is completed, the cutter 304 performs a cutting operation to cut the sheet 2. Further downstream of the cutter 304 in the conveyance direction F, the sheet discharge switching flapper 113 is provided. The sheet discharge switching flapper 113 is changeable between a posture (first posture) proximate to position E1 in FIG. 5 and a posture (second posture) proximate to position E2 in FIG. 3 by rotation. The sheet discharge switching flapper 113 is configured to rotate to the posture proximate to position E1 or the posture proximate to position E2 on the basis of control by the control portion 101, thereby switching a conveyance path of the sheet 2. When front sheet discharge is performed, the sheet discharge switching flapper 113 is positioned on the E2 side, and the conveyance portion 108 conveys the sheet 2 to the front sheet discharge portion 111.

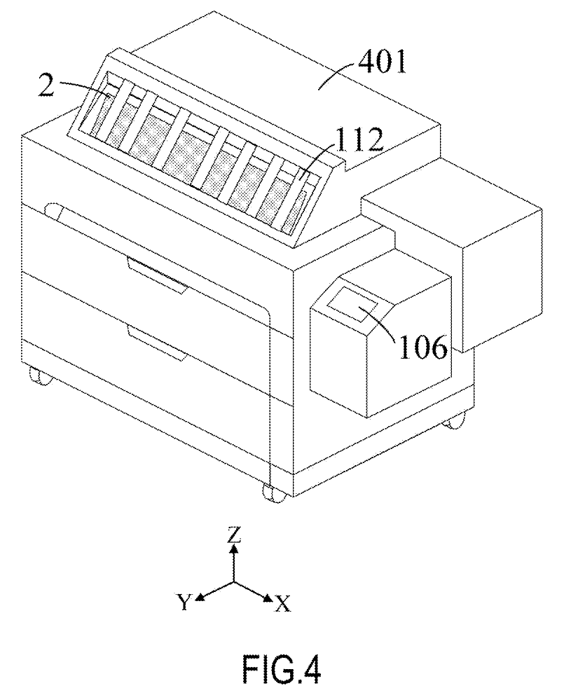

FIG. 4 is a schematic perspective view of the recording apparatus 100 during upper sheet discharge. FIG. 5 is a schematic cross-sectional view of the recording apparatus 100 during the upper sheet discharge. In the upper sheet discharge, the sheet discharge switching flapper 113 is positioned on the E1 side, and the sheet 2 recorded by the recording portion 109 is conveyed to the upper sheet discharge portion 112. The sheet 2 conveyed to the upper sheet discharge portion 112 is discharged onto a stacker 401 disposed at an upper portion of the recording apparatus 100, on which a plurality of recorded sheets 2 can be stacked.

The recording apparatus 100 according to this embodiment is configured to be capable of performing three types of discharge operations for the sheet 2 on which an image has been recorded. That is, the discharge operations include: upper sheet discharge (an upper sheet discharge operation) in which the sheet 2 is discharged from the recording portion 109 to the upper sheet discharge portion 112; front sheet discharge (a front sheet discharge operation) in which the sheet 2 is discharged from the recording portion 109 to the front sheet discharge portion 111; and a combined sheet discharge operation in which the front sheet discharge and the upper sheet discharge are combined. The third sheet discharge operation is specifically sheet discharge (an exposure discharge operation) in which a portion of the sheet 2 recorded by the recording portion 109 is once discharged to the front sheet discharge portion 111, is then returned from the front sheet discharge portion 111, and is discharged from the upper sheet discharge portion 112. The upper sheet discharge operation can be regarded as an operation in which the sheet is not discharged to the front sheet discharge portion 111 but is discharged from the upper sheet discharge portion 112. Furthermore, the front sheet discharge operation can be regarded as an operation in which the sheet is not discharged to the upper sheet discharge portion 112 but is discharged from the front sheet discharge portion 111. Hereinafter, the third sheet discharge operation may be referred to as “third sheet discharge” or a “third sheet discharge operation.”

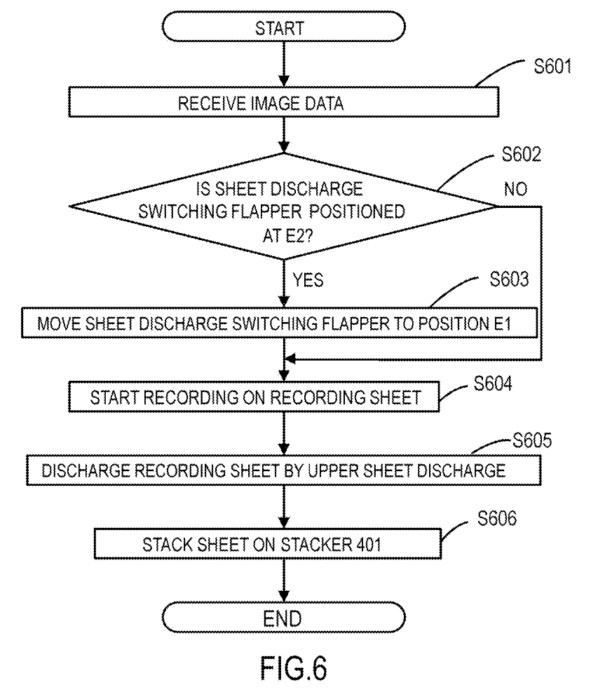

FIG. 6 illustrates a basic flowchart of the upper sheet discharge operation. Note that various operations illustrated in the flowchart of FIG. 6 are controlled by the control portion 101. During the upper sheet discharge, the sheet 2 is discharged with a recording area thereof facing downward. Therefore, a user cannot visually recognize a recording result during the sheet discharge operation. In the upper sheet discharge, when image data is transmitted via the recording apparatus driver 105 or the operation panel 106, the control portion 101 receives the image data from the host apparatus 114 in step S601 and starts a recording operation. In step S602, the control portion 101 confirms a position of the sheet discharge switching flapper 113. When the sheet discharge switching flapper 113 is positioned at E2, the control portion 101 moves the sheet discharge switching flapper 113 to position E1 in step S603. After recording is started in step S604, the recorded sheet 2 is conveyed by the conveyance portion 108 to the upper sheet discharge portion 112 in S605. The sheet 2 conveyed to the upper sheet discharge portion 112 is subjected to a cutting operation by the cutter 304 in S606 and is then discharged to the stacker 401 disposed at the upper portion of the recording apparatus 100. In this manner, a plurality of recorded sheets 2 are stacked.

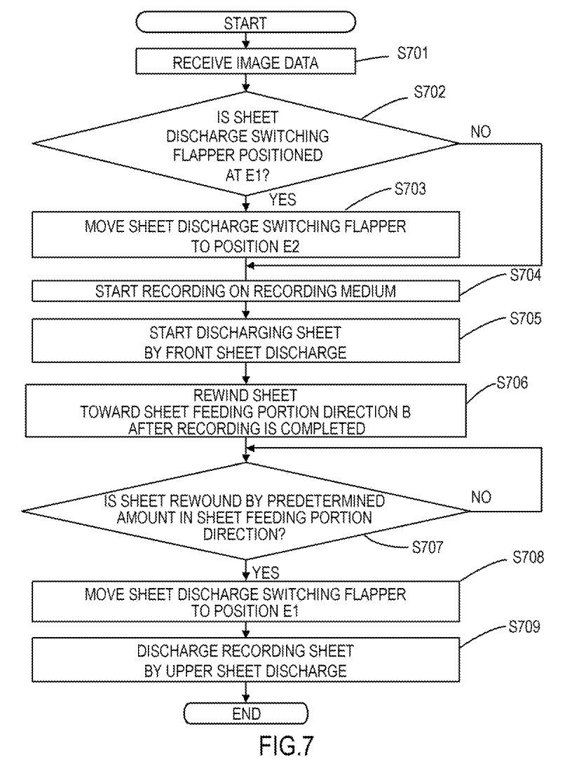

FIG. 7 illustrates a flowchart of the third sheet discharge operation. Note that various operations illustrated in the flowchart of FIG. 7 are controlled by the control portion 101. When image data is transmitted via the recording apparatus driver 105 or the operation panel 106, the control portion 101 receives the image data from the host apparatus 114 in step S701 and starts a recording operation. In step S702, the control portion 101 confirms, on the basis of a previous sheet discharge destination setting, whether the sheet discharge switching flapper 113 is positioned at E1. When the sheet discharge switching flapper 113 is positioned at E1, the control portion 101 moves the sheet discharge switching flapper 113 to position E2 in step S703. When the sheet discharge switching flapper 113 is not positioned at E1, the control portion 101 proceeds to step S704. In step S704, a recording operation is started on the sheet 2 conveyed to the recording portion 109 by the conveyance portion 108. Thereafter, in step S705, the conveyance portion 108 starts discharging the sheet to the front sheet discharge portion 111 with a recording area thereof facing upward such that the user can visually recognize the recording result. That is, the control portion 101 rotates the conveyance roller 301 in a predetermined rotation direction (conveyance direction), which is a clockwise direction in the figure in this embodiment, and rotates the rolled portion R of the supply portion 107 in a predetermined rotation direction (feeding direction), which is a clockwise direction in the figure in this embodiment. As a result, the sheet 2 is conveyed toward the recording portion 109. The recording portion 109 performs a recording operation on the sheet 2 thus conveyed. The recording portion 109 includes, for example, a carriage and a recording head (not illustrated). The carriage reciprocates in the X direction (main scanning direction) along a carriage shaft (not illustrated), and the recording head mounted on the carriage ejects ink onto a recording surface of the sheet 2 from ejection ports. The surface of the sheet 2 opposite to the recording surface is supported by a platen (not illustrated). In general front sheet discharge, when recording of a desired image is completed, conveyance of the sheet 2 is continued until a rear end of a predetermined area of the sheet 2 including the recorded image reaches a cutting position of the cutter 304. The conveyance is then stopped, and the sheet 2 is cut by the cutter 304. As a result, the predetermined area of the sheet 2 including the recorded image is separated as a printed matter. In contrast, in the front sheet discharge of the third sheet discharge operation, a cutting operation by the cutter 304 is not performed during control of the front sheet discharge.

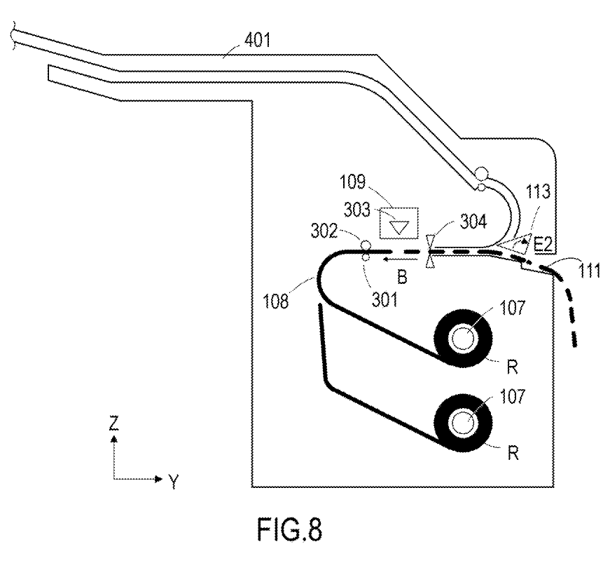

In step S706, after recording of one job is completed, the above-described cutting operation by the cutter 304 is not performed during control of the front sheet discharge, and the conveyance portion 108 performs a rewinding operation (reverse conveyance) toward a sheet feeding portion direction B. In step S707, the rewinding operation is continued until a predetermined amount is reached (FIG. 8). In this case, the predetermined amount is an amount of conveyance of the sheet 2 until a leading end of the sheet 2 is conveyed further toward the sheet feeding portion direction (upstream side) than a position of the sheet discharge switching flapper 113 (the branch point between the path leading to the upper sheet discharge portion 112 and the path leading to the front sheet discharge portion 111). During the rewinding operation of the sheet 2, the control portion 101 rotates the conveyance roller 301 in a direction opposite to a direction in which the sheet 2 is conveyed toward the recording portion 109 or the like. At the same time, the control portion 101 rotates the rolled portion R of the supply portion 107 in the direction (rewinding direction) opposite to the direction in which the sheet 2 is conveyed toward the recording portion 109 or the like. By rotation of the conveyance roller 301 and the rolled portion R, the sheet 2 is conveyed in the rewinding direction (opposite to the conveyance direction during recording) in which the sheet 2 is rewound onto the rolled portion R. A conveyance amount in the rewinding operation may be derived, for example, from a conveyance amount counted during a sheet discharge operation. As a specific configuration for counting the conveyance amount, for example, the conveyance amount may be counted on the basis of a rotation amount of the conveyance roller 301 or the like acquired using an encoder. Alternatively, the conveyance may be continued until the optical sensor 303 included in the recording portion 109 determines that the sheet 2 is no longer detectable. The third sheet discharge operation according to this embodiment is an operation in which, after the sheet 2 is temporarily reversely conveyed, the conveyance direction is returned to a normal conveyance direction for sheet discharge and pages (boundaries between a plurality of recorded sheets) are cut by the cutter 304. Although control of the conveyance amount is not limited to a specific method, it is preferable to employ a method by which the conveyance amount can be controlled more accurately since high accuracy is required for a cutting position between pages.

In step S708, the sheet discharge switching flapper is moved to position E1. In step S709, by the upper sheet discharge, recording area of the sheet 2 turned downward and discharged it. At this time, a portion of the recording area of the sheet 2 may be conveyed so as to be rewound to a position upstream of the recording portion 109 and then pass through the recording portion 109 again. Of course, the recording portion 109 does not perform a recording operation at this time. A rear end of a predetermined area of the sheet 2 including a recorded image and discharged to the upper sheet discharge portion 112 is cut by the cutter 304, and the cut portion is stacked on the stacker 401 as a printed matter separated from the sheet 2. Here, a job (an instruction to record an image on a recording material) received by the control portion 101 may be content in which one printed matter (one page) is output in accordance with one job, or content in which a plurality of pages are output in accordance with one job. That is, in some cases, a plurality of images are recorded on the sheet 2 in a single recording operation for one job, and after the single recording operation is completed, the sheet 2 is cut into a plurality of areas (pages) corresponding to the plurality of images to be output. In such a case, the sheet 2 is cut by the cutter 304 for each of the plurality of pages included in one job, and the cut pages are sequentially stacked on the stacker 401. There are also cases in which a plurality of types of jobs are received and executed continuously. For example, in consecutive first and second jobs, one printed matter (one page) may be output for each job, or a plurality of printed matters (a plurality of pages) may be output for each job. Alternatively, a plurality of printed matters (a plurality of pages) may be output in a first job and one printed matter may be output in a second job, or vice versa. That is, the number of output sheets may differ between consecutive jobs. Furthermore, in the flowchart illustrated in FIG. 7, when the same operation is repeated in a second job (second page) after a first job (first page), the processing may return from step S709 to step S702. When the same operation is not repeated, recording by the recording portion 109 and cutting by the cutter 304 may be performed until no jobs remain.

By the above-described sheet discharge operation, the sheet is once caused to pass through the front sheet discharge portion 111, which is a sheet discharge path where the user can visually recognize the recording result. In this manner, even when the sheet is discharged to the upper sheet discharge portion 112, which is a sheet discharge path where the user cannot visually recognize the recording result, it becomes possible to perform a sheet stacking operation after the user has confirmed the recording result. In this embodiment, a path in which the sheet is caused to pass through the front sheet discharge portion 111, that is, a path in which the sheet is conveyed toward the front sheet discharge portion 111 but is returned without being discharged is used as an exposure path in which the sheet 2 can be conveyed such that at least a portion of an image being recorded can be visually recognized from outside. The path for discharging the sheet from the recording portion 109 toward the upper sheet discharge portion 112 includes two types of paths. That is, these paths include a path (a first path) in which the sheet is conveyed straight from the recording portion 109 to the upper sheet discharge portion 112 and discharged (i.e., without passing through the exposure path), and a path (a second path) in which the sheet first passes through the exposure path and is then conveyed to and discharged from the upper sheet discharge portion 112. The exposure path is not limited to a mode using the front sheet discharge portion 111 as in this embodiment. A conveyance path that does not have a sheet discharge function but is capable of exposing the recording surface of the sheet 2 may be provided separately from a path in which the sheet 2 is directly conveyed to the upper sheet discharge portion 112.

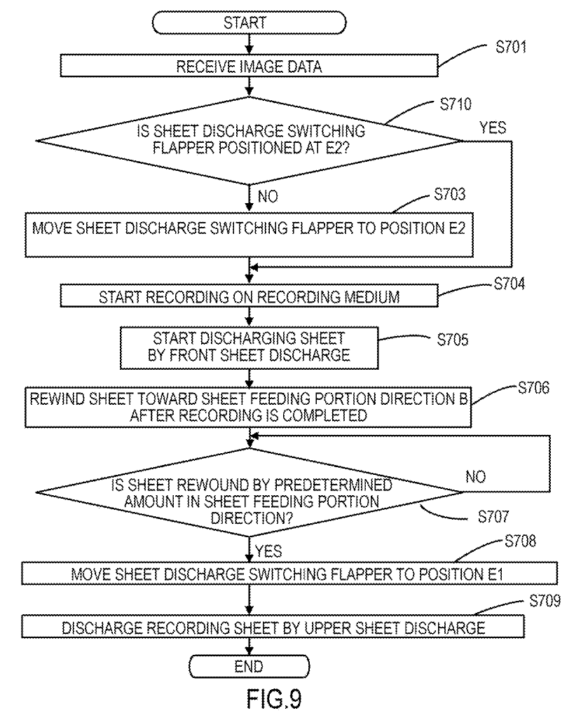

FIG. 9 illustrates a modified example of the flowchart of the third sheet discharge operation illustrated in FIG. 7, in which step S702 in the flowchart of FIG. 7 is replaced with step S710. In step S710, the control portion 101 confirms, on the basis of a previous sheet discharge destination setting, whether the sheet discharge switching flapper 113 is positioned at E2. When the sheet discharge switching flapper 113 is not positioned at E2, the control portion 101 moves the sheet discharge switching flapper 113 to position E2 in step S703. When the sheet discharge switching flapper 113 is positioned at E2, the control portion 101 proceeds to step S704. The other steps in the flowchart of FIG. 9 are the same as those in the flowchart of FIG. 7.

### SECOND EMBODIMENT

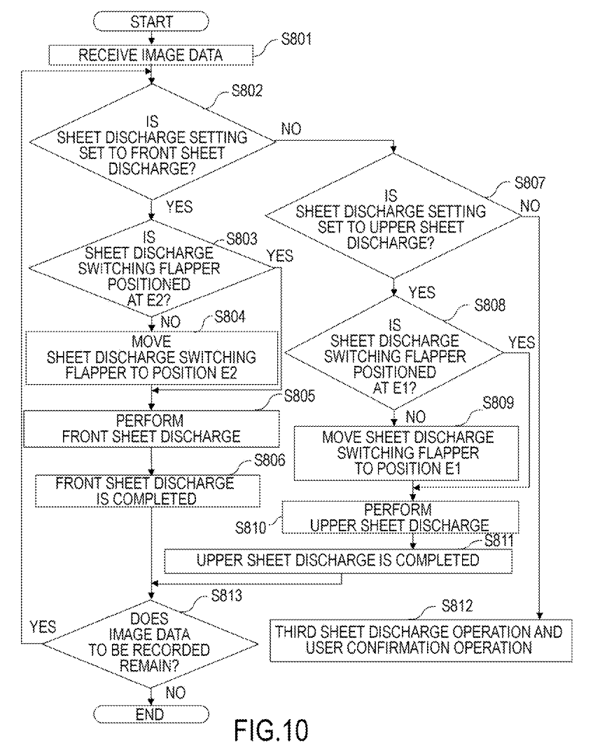

A recording apparatus according to a second embodiment of the present disclosure will be described with reference to FIGS. 10 - 13. The configuration of the recording apparatus according to this embodiment is the same as that of the recording apparatus according to the first embodiment. The recording apparatus according to this embodiment is characterized by a third sheet discharge operation performed for a plurality of sheets 2 in a continuous recording operation in which images are continuously recorded on the plurality of sheets 2.

In the third sheet discharge operation of this embodiment, the control portion 101 is configured to be capable of temporarily stopping conveyance of a sheet 2 and a recording operation on the sheet 2 in an exposure path in which at least a portion of an image being recorded on the sheet 2 is visually recognizable from outside, and performing a confirmation operation for prompting a user to confirm whether to continue the recording. When continuation of the recording is requested by the user in the confirmation operation, the control portion 101 resumes the conveyance of the sheet 2 and the recording of the image on the sheet 2. After the recording of the image is completed, the control portion 101 reversely conveys the sheet 2 from the front sheet discharge portion 111 and then conveys and discharges the sheet 2 to the upper sheet discharge portion 112. When continuation of the recording is not requested by the user in the confirmation operation, the control portion 101 is configured to be capable of performing a resetting operation for prompting the user to reset recording operation settings. When the user resets the recording operation settings in the resetting operation, the control portion 101 resumes recording of an image with the reset recording operation settings. When the user does not reset the recording operation settings in the resetting operation, the control portion 101 interrupts the recording of the image.

### Description of First Recording Result Confirmation Operation Flow

FIG. 10 is a flowchart illustrating a recording result confirmation operation according to this embodiment. Note that various operations illustrated in the flowchart of FIG. 10 are controlled by the control portion 101. In step S801, the recording apparatus 100 receives image data to be recorded via the recording apparatus driver 105 or the operation panel 106 and starts a recording operation (start of the flow). In this embodiment, a recording result confirmation operation flow will be described assuming that a plurality of image data items are continuously received from the same user in step S801. The plurality of image data items may be the same or different. Even when the plurality of image data items are different from each other, it is possible to confirm whether settings that do not depend on whether the image data items are the same, such as sizes of the image data items recorded on a recording sheet or a degree of a layout, match user’s intention. Therefore, the image data items are not limited to be the same.

In step S802, the control portion 101 confirms a sheet discharge setting for the received image data to be recorded. When the sheet discharge setting is front sheet discharge, the processing proceeds to step S803. When the sheet discharge setting is a setting other than the front sheet discharge, that is, upper sheet discharge or third sheet discharge, the processing proceeds to step S807.

In step S803, the control portion 101 confirms whether the sheet discharge switching flapper 113 is positioned at E2. When the sheet discharge switching flapper 113 is not positioned at E2, the control portion 101 moves the sheet discharge switching flapper 113 to position E2 in step S804. When the sheet discharge switching flapper 113 is positioned at E2, the processing proceeds to step S805. In step S805, the received image data to be recorded is recorded on the sheet 2. The recorded matter is discharged by the front sheet discharge, and cut by the cutter 304. When the front sheet discharge is completed, the processing proceeds to step S813 (step S806).

In step S807, the control portion 101 confirms the sheet discharge setting for the received image data to be recorded. When the sheet discharge setting is the upper sheet discharge, the processing proceeds to step S808. When the sheet discharge setting is not the upper sheet discharge, that is, the third sheet discharge, the processing proceeds to step S812.

In step S808, the control portion 101 confirms whether the sheet discharge switching flapper 113 is positioned at E1. When the sheet discharge switching flapper 113 is not positioned at E1, the control portion 101 moves the sheet discharge switching flapper 113 to position E1 in step S809. When the sheet discharge switching flapper 113 is positioned at E1, the processing proceeds to step S810. In step S810, the received image data to be recorded is recorded on the sheet 2. The recorded matter is discharged by upper side discharge, cut by the cutter 304, and then stacked on the stacker 401. When the upper sheet discharge is completed, the processing proceeds to step S813 (step S811).

In step S812, the third sheet discharge operation and a user confirmation operation are performed. Details of this step will be described later. When step S812 is completed, the processing proceeds to step S813, or the first recording result confirmation operation flow ends (branch conditions will be described later).

In step S813, the control portion 101 confirms whether any image data to be recorded received in step 801 remains. When image data to be recorded remains, the processing proceeds to step S802, and the control portion 101 confirms a sheet discharge setting for the next image data to be recorded. When no image data to be recorded does remain, the first recording result confirmation operation ends.

As described above, according to the second embodiment, when the control portion 101 continuously receives a plurality of image data items from the same user, the user who provided a recording instruction confirms the recording result, thereby making it possible to select whether to continue recording on the basis of the result.

### Description of Flow of Sub-Process S812 of Third Sheet Discharge Operation and User Confirmation Operation

In step S812, the control portion 101 prompts the user to confirm, during the third sheet discharge operation, the recorded matter on which the image data has been recorded, and prompts the user to confirm whether to continue recording of the remaining received image data to be recorded. The timing for prompting the user to make the above confirmation may be set at any step in FIGS. 7 or 9 (the third sheet discharge operation flow).

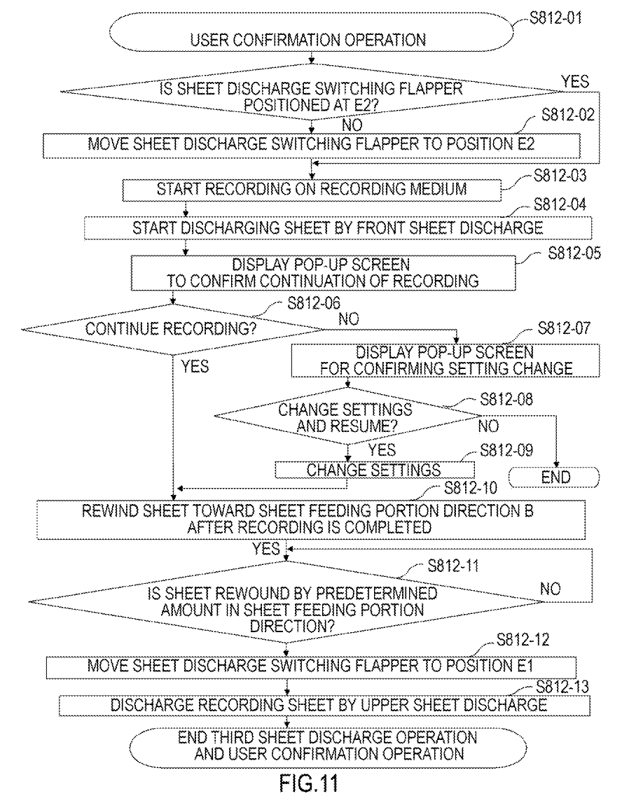

The flow of the sub-process (S812) of the third sheet discharge operation and the user confirmation operation will be described with reference to a flowchart illustrated in FIG. 11. Note that various operations of the flowchart illustrated in FIG. 11 are controlled by the control portion 101. When the sub-process in step S812 starts, step S812-01 is performed. In step S812-01, as in step S710 of FIG. 9, the control portion 101 confirms whether the sheet discharge switching flapper 113 is positioned at E2. When the sheet discharge switching flapper 113 is not positioned at E2, the control portion 101 moves the sheet discharge switching flapper 113 to position E2. When the sheet discharge switching flapper 113 is positioned at E2, the processing proceeds to step S812-03.

In step S812-03, as in step S704 of FIGS. 7 and 9, recording is started on the sheet 2 conveyed to the recording portion 109 by the conveyance portion 108. In step S812-04, as in step S705 of FIGS. 7 and 9, the conveyance portion 108 starts discharging the sheet to the front sheet discharge portion with the recording area facing upward such that the user can visually recognize the recording result.

In step S812-05, the control portion 101 displays, on the operation panel 106, a screen that allows the user to select whether to continue recording of the image data to be recorded. In FIG. 11, for the sake of convenience, user confirmation operations in steps S812-05 to S812-09 are performed after step S812-04, but the timing for performing the user confirmation operations may be at any step in this flow (FIG. 11). For example, the user confirmation operations may be performed after step S812-03, or performed in parallel with steps S812-04 to S812-12.

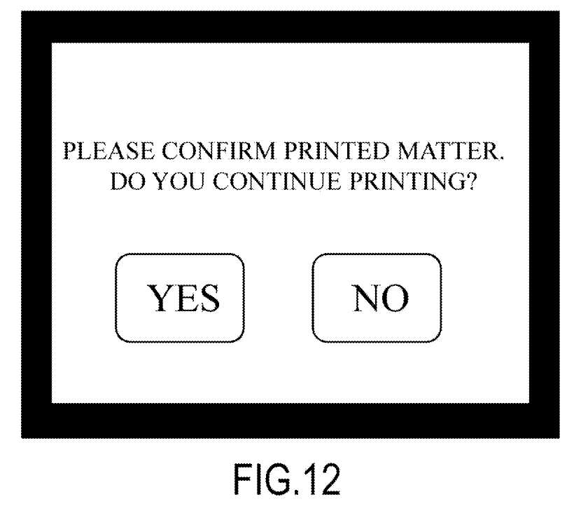

FIG. 12 illustrates an example of the above-described screen. The screen displays, in addition to the words “Please confirm the printed matter.” prompting the user to confirm the recorded matter, the words “Do you continue printing?” displayed below to prompt the user to confirm whether to continue recording of the remaining image data. Moreover, the words “YES” and “NO” are also displayed as selectable responses. FIG. 12 merely illustrates these words as an example, and displayed screen information such as words, arrangements, and sizes are not intended to be limited to those illustrated in FIG. 12.

In step S812-06, the flow branches when the user selects “YES” or “NO" displayed in step S812-05. When “YES” is selected, the processing proceeds to step S812-10. When “NO” is selected, the processing proceeds to step S812-07.

In step S812-07, the control portion 101 displays, on the operation panel 106, a screen that allows the user to select whether to change settings for recording of the remaining image data and continue the recording. Examples of the settings for the recording include an ink ejection amount for recording the image data, a size of the image data to be recorded, or the like. The settings for the recording described here are merely examples and are not intended to limit the scope of the present disclosure.

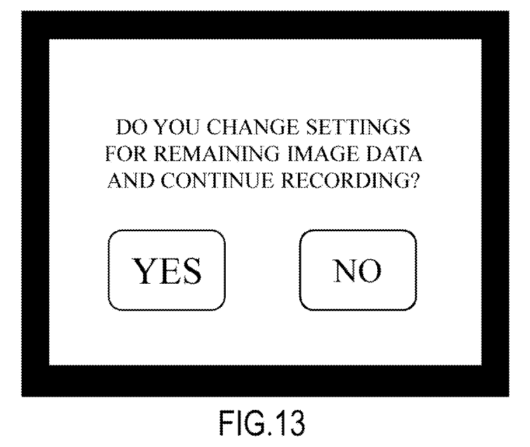

FIG. 13 illustrates an example of the above-described screen. The screen displays the words “Do you change the settings for the remaining image data and continue recording?” to prompt the user to confirm whether to change the settings for recording of the remaining image data. Moreover, the words “YES” and “NO” are also displayed as selectable responses. FIG. 13 merely illustrates these words as an example, and displayed information such as words, arrangements, and sizes are not intended to be limited to those illustrated in FIG. 13.

In step S812-08, the flow branches when the user selects “YES” or “NO" displayed in step S812-07. When “YES” is selected, the processing proceeds to step S812-09. When “NO” is selected, the processing proceeds through the same steps as steps S706 to S709 illustrated in FIGS. 7 and 9, and the first recording result confirmation operation flow illustrated in FIG. 10 ends when the sub-process (S812) is completed.

In step S812-09, the user changes settings for recording of the remaining image data via the recording apparatus driver 105 of the external host apparatus 114 or the operation panel 106. When the change is completed, the processing proceeds to step S812-10. In step S812-10, as in step S706 of FIGS. 7 and 9, the conveyance portion 108 performs a rewinding operation toward the sheet feeding portion direction B. In step S812-11, the rewinding operation is continued until a predetermined amount is reached.

In step S812-12, as in step S708 of FIGS. 7 and 9, the sheet discharge switching flapper is moved to position E1. In step S812-13, by the upper sheet discharge, recording area of the sheet 2 turned downward and discharged it. The discharged sheet 2 is cut by the cutter 304 and stacked on the stacker 401. When step S812-13 is completed, the flow of the sub-process (S812) of the third sheet discharge operation and the user confirmation operation ends, and the processing proceeds to step S813 in the first recording result confirmation operation flow illustrated in FIG. 10.

In this embodiment, when recording operation settings are reset, an image to be recorded is an image in which a portion recorded with the settings before the resetting and a portion recorded with the settings after the resetting are mixed. That is, it becomes possible to compare the quality of the image before and after the resetting in a single image. However, the operation performed when the resetting is performed is not limited to this. For example, when the user resets recording operation settings, the sheet 2 on which an image based on the settings before the resetting was being recorded may be discarded as it is, and recording of an image may be restarted from the beginning with the reset recording operation settings.

In this embodiment, continuation of recording is confirmed, and when the continuation is not requested, the user is prompted to review the settings. However, the present invention is not limited to such a configuration. For example, when the continuation is not requested, a recording operation may be completed without prompting the user to review the settings.

### THIRD EMBODIMENT

### Description of Second Recording Result Confirmation Operation Flow

In the second embodiment, a basic flow is described in which, when a plurality of image data items are continuously received from the same user, the user who provided a recording instruction confirms the recording result and selects whether to continue subsequent recording on the basis of the result. That is, in a continuous recording operation in which recording is continuously performed on a plurality of sheets 2 and the sheets 2 are then discharged to the upper sheet discharge portion 112, all the plurality of sheets 2 are conveyed in the third sheet discharge operation.

In a third embodiment, a case will be described in which, when a plurality of image data items are continuously received from the same user, a first recorded matter is cut after discharging by the front sheet discharge, thereby prompting the user to confirm the recorded state. Specifically, in a continuous recording operation in which recording is continuously performed on a plurality of sheets 2, at least a first sheet 2 is discharged to the front sheet discharge portion 111 to prompt the user to confirm the recorded state. That is, unlike the third sheet discharge operation performed in the first and second embodiments, by the front sheet discharge, the sheet 2 is cut by the cutter 304 and discharged it. Then, a confirmation operation for prompting the user to confirm whether to continue recording on the remaining sheets 2 is performed. When continuation of the recording is not requested by the user during the confirmation operation, a resetting operation for prompting the user to reset recording operation settings is performed. A sheet 2 on which an image has been recorded with the reset recording operation settings is discharged by the front sheet discharge, and a confirmation operation for prompting the user to confirm the recorded state is performed again. When continuation of the recording is requested, recording on the remaining recording materials is continued in the set discharge operation. The basic configuration of the third embodiment is the same as that of the example described in the second embodiment.

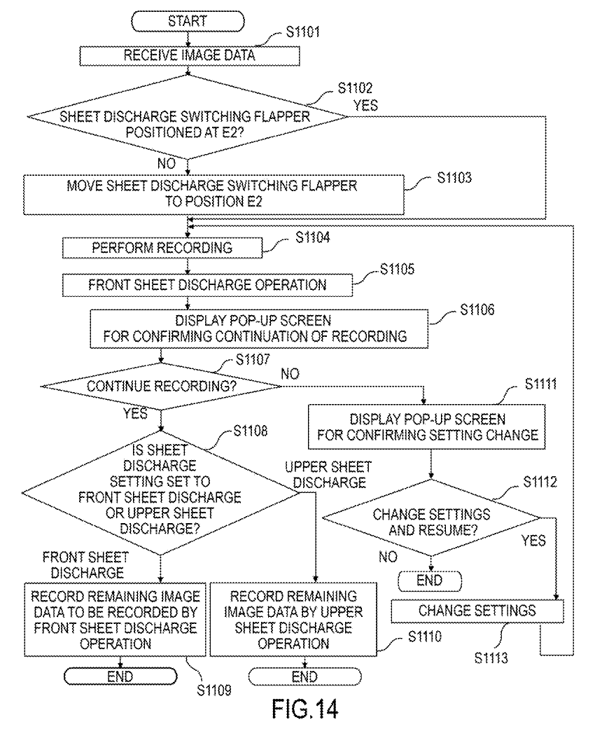

FIG. 14 is a flowchart illustrating a recording result confirmation operation according to this embodiment. Note that various operations illustrated in the flowchart of FIG. 14 are controlled by the control portion 101. When the flow starts, in step S1101, the recording apparatus 100 receives image data to be recorded via the recording apparatus driver 105 or the operation panel 106 and starts a recording operation. In this embodiment, a recording result confirmation operation flow will be described assuming that a plurality of image data items are continuously received from the same user in step S1101. The plurality of image data items may be the same or different. Even when the plurality of image data items are different from each other, it is possible to confirm whether settings that do not depend on whether the image data items are the same, such as sizes of the image data items recorded on a recording sheet or a degree of a layout, match user’s intention. Therefore, the image data items are not limited to be the same.

In step S1102, the control portion 101 confirms whether the sheet discharge switching flapper 113 is positioned at E2. When the sheet discharge switching flapper 113 is not positioned at E2, the control portion 101 moves the sheet discharge switching flapper 113 to position E2 in step S1103. When the sheet discharge switching flapper 113 is positioned at E2, the processing proceeds to step S1104. In step S1104, a recording operation is started on the sheet 2 conveyed to the recording portion 109 by the conveyance portion 108.

In step S1105, the recorded matter recorded in step S1104 is discharged by the front sheet discharge with the recording area thereof facing upward such that the user can visually recognize the recording result, and after completion of the recording, the recorded matter is cut by the cutter 304.

In step S1106, the control portion 101 displays, on the operation panel 106, a screen (FIG. 12) that allows the user to select whether to continue recording of the image data to be recorded. This step is the same as step S812-05 in the flow of the sub-process (S812) of the third sheet discharge operation and the user confirmation operation illustrated in FIG. 11.

In step S1107, the flow branches when the user selects “YES” or “NO" displayed in step S1106. When “YES” is selected, the processing proceeds to step S1108. When “NO” is selected, the processing proceeds to step S1111.

In step S1108, the control portion 101 confirms a sheet discharge setting for the received image data to be recorded. When the sheet discharge setting is set to front sheet discharge, the processing proceeds to step S1109. When the sheet discharge setting is set to upper sheet discharge, the processing proceeds to step S1110. In step S1109, the remaining image data is recorded, and all the sheets are discharged in a front sheet discharge operation. The recorded matters thus discharged are cut by the cutter 304. In step S1110, the remaining image data is recorded, and all the sheets are discharged in an upper sheet discharge operation. The recorded matters thus discharged are cut by the cutter 304 and stacked on the stacker 401.

In step S1111, the control portion 101 displays, on the operation panel 106, a screen (FIG. 13) that allows the user to select whether to change settings for recording of the remaining image data and continue the recording. This step is the same as step S812-07 in the sub-process (S812) of the third sheet discharge operation and the user confirmation operation illustrated in FIG. 11.

In step S1112, the flow branches when the user selects “YES” or “NO" displayed in step S1111. When “YES” is selected, the processing proceeds to step S1113. When “NO” is selected, the second recording result confirmation operation flow ends.

In step S1113, the user changes settings for recording of the remaining image data via the recording apparatus driver 105 of the external host apparatus 114 or the operation panel 106. When the change is completed, the processing proceeds to step S1104. Although the processing proceeds to step S1104 in this embodiment, the processing may proceed to step S1109 or step S1110 on the basis of a sheet discharge method setting. That is, after a recording state of an image has been once confirmed and recording operation settings have been reset, an operation for confirming continuation or an operation for confirming setting changes may not be performed in recording of the remaining sheets 2. In other words, an operation for prompting the user to confirm quality after the resetting may be omitted.

According to the third embodiment, when the control portion 101 continuously receives a plurality of image data items from the same user, a first recorded matter that has undergone recording is discharged by the front sheet discharge, thereby prompting the user who provided a recording instruction to confirm the recording result. This makes it possible to select whether to continue subsequent recording on the basis of the recording result.

According to the present disclosure, it becomes possible to reduce wasteful recording operations.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-082612, filed May 16, 2025, which is hereby incorporated by reference herein in its entirety.

What is claimed is:

1. A recording apparatus comprising:
a recording portion configured to record an image on a recording material;
a first discharge portion configured to discharge the recording material in a posture in which a recording surface on which the image has been recorded by the recording portion is not visually recognizable from outside;
a second discharge portion configured to discharge the recording material in a posture in which the recording surface on which the image has been recorded by the recording portion is visually recognizable from outside; and
a control portion configured to control the recording portion and conveyance of the recording material, wherein
the control portion performs a discharge operation that includes discharging a portion of the recording material on which the image has been recorded by the recording portion to the second discharge portion, then returning the recording material from the second discharge portion, and then discharging the recording material from the first discharge portion, and
during the discharge operation, the control portion temporarily stops the conveyance of the recording material and the recording of the image while at least a portion of the recording surface of the recording material on which the image has been recorded by the recording portion is visually recognizable from outside.

2. The recording apparatus according to claim 1, wherein
the control portion reversely conveys, during the discharge operation, the recording material after discharging the portion of the recording material on which the image has been recorded by the recording portion to the second discharge portion, thereby returning the recording material from the second discharge portion.

3. The recording apparatus according to claim 2, further comprising:
a flapper provided at a branch point between a path leading from the recording portion to the first discharge portion and a path leading from the recording portion to the second discharge portion, the flapper being controlled by the control portion to be selectively movable between a first posture and a second posture, wherein
the flapper permits the recording material to move toward the first discharge portion while restricting the recording material from moving toward the second discharge portion in the first posture, and restricts the recording material from moving toward the first discharge portion while permitting the recording material to move toward the second discharge portion in the second posture, and wherein
during the discharge operation, the control portion sets the flapper in the second posture, discharges the portion of the recording material on which the image has been recorded by the recording portion to the second discharge portion, reversely conveys the recording material from the second discharge portion to a position upstream of the branch point, and changes the posture of the flapper from the second posture to the first posture.

4. The recording apparatus according to claim 1, wherein
the first discharge portion includes a stacking surface on which the recording material is stacked, and
the stacking surface faces the recording surface of the stacked recording material.

5. The recording apparatus according to claim 1, wherein
the control portion is configured to be capable of performing a confirmation operation for prompting a user to confirm whether to continue the recording in a state in which the conveyance of the recording material and the recording of the image are temporarily stopped during the discharge operation.

6. The recording apparatus according to claim 5, wherein
in a case in which continuation of the recording is requested by the user in the confirmation operation, the control portion resumes the conveyance of the recording material and the recording of the image, and, after the recording of the image is completed, returns the recording material from the second discharge portion and discharges the recording material to the first discharge portion.

7. The recording apparatus according to claim 5, wherein
in a case in which continuation of the recording is not requested by the user in the confirmation operation, the control portion ends the recording of the image.

8. The recording apparatus according to claim 5, wherein
in a case in which continuation of the recording is not requested by the user in the confirmation operation, the control portion is configured to be capable of performing a resetting operation for prompting the user to reset a recording operation setting.

9. The recording apparatus according to claim 8, wherein
in a case in which the user resets the recording operation setting in the resetting operation, the control portion resumes the recording of the image with the reset recording operation setting.

10. The recording apparatus according to claim 8, wherein
in a case in which the user does not reset the recording operation setting in the resetting operation, the control portion ends the recording of the image.

11. The recording apparatus according to claim 8, wherein
in a case in which the user resets the recording operation setting in the resetting operation, the control portion restarts recording of an image from a beginning with the reset recording operation setting and conveys, in the discharge operation, the recording material on which the recording of the image has been restarted.

12. The recording apparatus according to claim 1, wherein
in a continuous recording operation in which recording is continuously performed on a plurality of the recording materials and the plurality of the recording materials are discharged to the first discharge portion,
the control portion conveys all the plurality of the recording materials in the discharge operation.

13. The recording apparatus according to claim 1, wherein
the discharge operation is a third discharge operation, and
the control portion is capable of performing
a first discharge operation in which the recording material is discharged from the first discharge portion without being discharged to the second discharge portion and
a second discharge operation in which the recording material is discharged from the second discharge portion.

14. The recording apparatus according to claim 13, wherein
in a continuous recording operation in which recording is continuously performed on a plurality of the recording materials and the plurality of the recording materials are discharged to the first discharge portion,
the control portion is configured to
discharge at least a first one of the plurality of the recording materials in the second discharge operation,
perform a confirmation operation for prompting a user to confirm whether to continue recording on a remaining recording material,
perform, in a case in which continuation of the recording is not requested by the user in the confirmation operation, a resetting operation for prompting the user to reset a recording operation setting,
discharge, in the second discharge operation, a recording material on which an image has been recorded with the reset recording operation setting,
perform the confirmation operation again, and
continue, in a case in which continuation of the recording is requested, the recording on the remaining recording material in the set discharge operation.

15. The recording apparatus according to claim 13, wherein
in a case in which a plurality of instructions for recording an image on a recording material are received,
recording based on a first instruction among the plurality of instructions is performed in the third discharge operation, and
recording based on a second instruction received after the first instruction is performed in the first discharge operation or the second discharge operation.

16. The recording apparatus according to claim 13, wherein
in a case in which an instruction for recording the image on the recording material is received, the instruction indicating that a plurality of the images corresponding to a plurality of the recording materials are recorded in a single recording operation,
recording on a first one of the plurality of the recording materials is performed in the third discharge operation, and
recording on a second or subsequent recording material is performed in the first discharge operation or the second discharge operation.

17. The recording apparatus according to claim 1, wherein
the recording material is a roll sheet in which a sheet is wound.

18. A recording apparatus comprising:
a recording portion configured to record an image on a recording material;
a discharge portion configured to discharge the recording material on which the image has been recorded;
a conveyance path configured to convey the recording material on which the image has been recorded to the discharge portion; and
a control portion configured to control the recording portion and conveyance of the recording material, wherein
the conveyance path includes an exposure path capable of conveying the recording material such that at least a portion of an image being recorded is visually recognizable from outside, and wherein
the control portion is configured to be capable of stopping the conveyance of the recording material and the recording of the image and performing a confirmation operation for prompting a user to confirm whether to continue the recording, in a state in which at least the portion of the image being recorded is visually recognizable from outside in the exposure path.
